(19) United States
(12) Patent Application Publication
(10) Pub. No.: US 2026/0239491 A1
(43) Pub. Date: Aug. 13, 2026

(54) SYSTEMS AND METHODS FOR CONNECTION MANAGEMENT

(71) Applicant: Comcast Cable Communications, LLC, Philadelphia, PA (US)

(72) Inventors: Soumya MUNSHI, CAMPBELL, CA (US); Raja SHAH, San Jose, CA (US); Naveen Kumar Raju VYSYARAJU, MALVERN, PA (US); Sunil Narayanan ANIYAMBETH, DOWNINGTOWN, PA (US); Peter AHIMOVIC, Fair Haven, NJ (US)

(21) Appl. No.: 19/048,802

(22) Filed: Feb. 7, 2025

(51) Int. Cl. H04W 76/30; H04B 17/309; H04W 76/19; H04W 84/12

(52) U.S. Cl. CPC H04W 76/30; H04B 17/346; H04W 76/19; H04W 84/12

(57) ABSTRACT

Methods and systems for connection management are disclosed. An access point may receive uplink frames from a mobile device. The access point may utilize the uplink frames to determine a variation in signal-to-noise ratio (SNR) associated with the mobile device. If the variation in SNR indicates that the mobile device is transient and the mobile device has not already joined a network, the access point may prevent the mobile device from joining the network. If the variation in SNR indicates that the mobile device is transient and the mobile device has already joined the network, the access point may force the mobile device to disconnect from the network.

### BACKGROUND

User devices may establish a connection with a network connection via an access point (AP). One or more of the user devices may move out of range of the AP and disconnect from the network shortly after establishing the connection with the network. This rapid connection to, and disconnection from, the network may negatively impact continuity of service to the user device(s). Further, the maintenance of such transient connections may waste valuable network resources. These and other shortcomings are addressed by the present disclosure.

### SUMMARY

Methods, systems, and devices for connection management are disclosed. A user may carry a device (e.g., a cellular phone, tablet, etc.) as the user travels to different locations. The device may be brought into a coffee shop. An access point located at the coffee shop may receive a request, from the device, to join a network. As the user stands in line at the coffee shop, the access point may determine that the device is not transient (e.g., not moving rapidly away from the access point) by determining a low variation in energy associated with the device. If the access point determines that the device is not transient, the access point may admit the device to the network. If the device is then carried out of the coffee shop, the access point may determine that the device is transient (e.g., moving rapidly away from the access point) by determining a high variation in energy associated with the device. If the access point determines that the device is transient, the access point may force the device to disconnect from the network (e.g., while the device is still located within a coverage area of the access point).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1A is an example system.

FIG. 1B is an example system.

FIG. 2 is an example system.

FIG. 3A is an example method.

FIG. 3B is an example method.

FIG. 3C is an example method.

FIG. 4 is an example method.

FIG. 5 is an example method.

FIG. 6 is an example method.

FIG. 7 is an example computing device.

### DETAILED DESCRIPTION OF ILLUSTRATIVE EMBODIMENTS

Methods and systems for connection management are disclosed. Mobile user devices, such as user devices located in fast moving vehicles, may be in range of a Wi-Fi network for only a short amount of time. This type of scenario can cause a variety of user experience problems if the mobile device is allowed to connect to the Wi-Fi network. Some user devices may disconnect from a cellular network if the user device is connected to a Wi-Fi network. As such, if the user device connects to, and then disconnects from, the Wi-Fi network within a short amount of time, a noticeable delay may occur in between the user device disconnecting from the Wi-Fi network and reconnecting to the cellular network. This delay may cause a discontinuity of service to the user device, thereby negatively impacting the user experience. Further, the establishment and maintenance of transient connections between mobile devices and the network may cause unnecessary utilization of the resources of the Wi-Fi network, thereby causing user-experience problems for other devices connected to the Wi-Fi network. As such, techniques for managing transient connections are needed.

Described herein are techniques for managing transient connections. Before a user device is admitted to a network (e.g., a Wi-Fi network), a user device may transmit uplink management (e.g., unicast or broadcast) frames to a wireless access point. Each of the uplink management frames may be associated with a signal-to-noise ratio (SNR) associated with the user device. The access point may utilize the uplink management frames to determine a variation in (e.g., gradient of, change in) the SNR associated with the user device. The variation in the SNR associated with the user device may indicate the characteristics of the motion (if any) of the user device relative to the network. For example, the absolute value of the SNR variation may indicate how quickly the user device is moving—the higher the absolute value of the SNR variation, the more quickly the user device may be moving.

If the absolute value of the SNR variation is above an association threshold, this may indicate that the user device is rapidly moving, and is therefore likely to disconnect from the network shortly after being admitted to the network. If the user device is likely to disconnect from the network shortly after being admitted to the network, the access point may not admit the user device to the network, thereby preventing a transient connection between the user device and the network from being formed. Conversely, if the absolute value of the SNR variation is less than or equal to the association threshold, this may indicate that the user device is not rapidly moving and is therefore not likely to disconnect from the network shortly after being admitted to the network. If the user device is not likely to disconnect from the network shortly after being admitted to the network, the access point may admit the user device to the network.

After the user device is admitted to the network, the user device may transmit uplink data frames to the access point. Each of the uplink data frames may be associated with a SNR (e.g., or other energy metric) associated with the connected user device. The access point may utilize the uplink data frames to determine a variation in (e.g., gradient of, change in) the SNR associated with the connected user device. The variation in the SNR associated with the connected user device may indicate the characteristics of the motion (if any) of the user device relative to the network. For example, the absolute value of the SNR variation may indicate how quickly the user device is moving—the higher the absolute value of the SNR variation, the more quickly the user device may be moving.

If the absolute value of the SNR variation is above a disassociation threshold, this may indicate that the connected user device is rapidly moving away from the access point. If the user device is rapidly moving away from the access point, the access point may force the user device to disconnect from the network (e.g., while the user device is still located within a coverage area of the access point), thereby minimizing the number of transient connections that exist within the network. Conversely, if the absolute value of the SNR variation is less than or equal to the disassociation threshold, this may indicate that the connected user device is not rapidly moving away from the access point. If the user device is not rapidly moving away from the access point, the access point may not force the user device to disconnect from the network. The user device may remain connected to the network via the access point. The access point may continue to monitor the absolute value of the SNR variation. If the user device later begins to rapidly move away from the access point, the access point may force the user device to disconnect from the network.

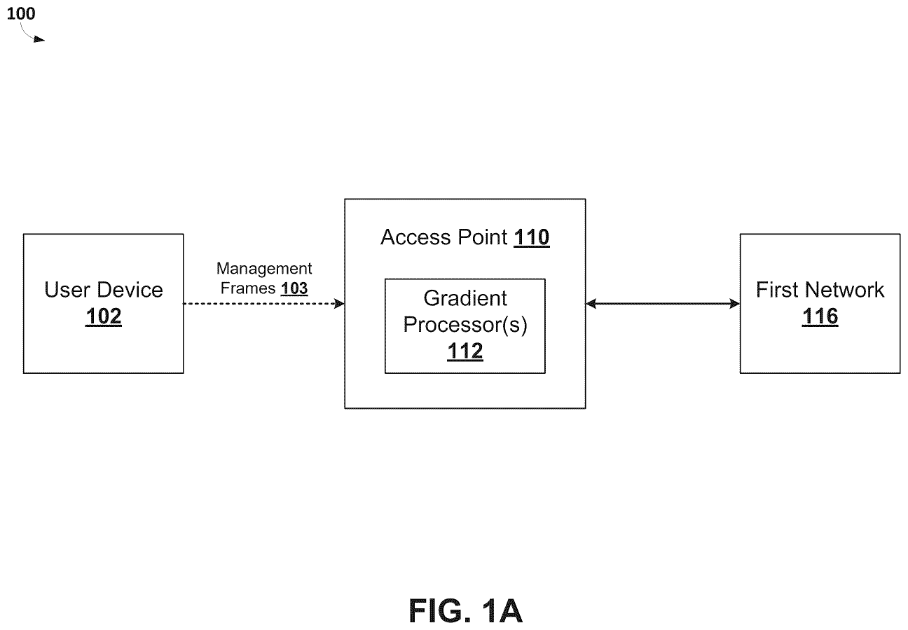

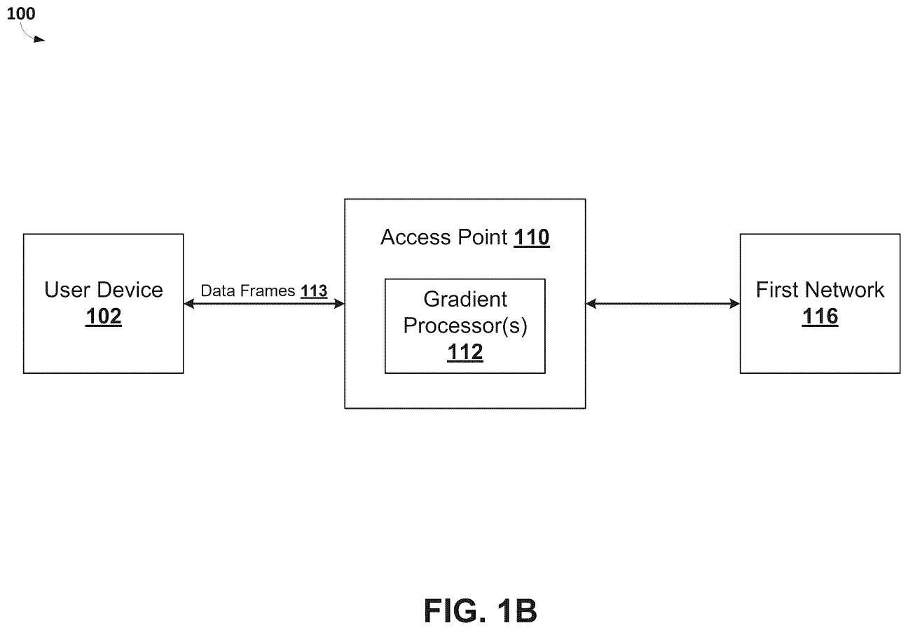

FIG. 1A is an example system 100. The system 100 may comprise a user device 102, an access point 110 (e.g., router device, gateway device, modem, computing device, etc.), and a first network 116. It should be noted that while the singular term device is used herein, it is contemplated that some devices may be implemented as a single device or a plurality of devices (e.g., via load balancing). The user device 102, the access point 110, and the first network 116 may each be implemented as one or more computing devices. Any device disclosed herein may be implemented using one or more computing nodes, such as virtual machines, executed on a single device and/or multiple devices.

The first network 116 may comprise a service entity, content provider (e.g., distributor) and/or access network. The first network 116 may facilitate communication via one or more communication protocols. The first network 116 may comprise any of a variety of types of networks, such as, for example, a coaxial cable network, a fiber-optic cable network, a hybrid fiber-coaxial (HFC) network, a satellite transmission channel, a DSL connection, or the like. The first network 116 may comprise fiber, cable, a combination thereof. The first network 116 may comprise wired links, wireless links, a combination thereof, and/or the like. The first network 116 may comprise routers, switches, nodes, gateways, servers, modems, and/or the like. The first network 116 may comprise one or more networks, such as a wide area network (e.g., the Internet), a cellular network, a Wi-Fi network, a Long Term Evolution (LTE) network, one or more service entity networks, and/or the like. The first network 116 may be a converged network, having capabilities to route traffic over various communication networks, such as a cellular network, a Wi-Fi network, etc.

The access point 110 may be located at a premises. The premises may comprise a property, dwelling, terminal, building, floor, and/or the like. The premises may comprise different rooms, walls, door, windows, and/or the like. The premises may include an area within a coverage range (e.g., wireless range) of the access point 110. The user device 102 may move within and/or outside the premises. The access point 110 may be fixed at a stationary location within the premises. The user device 102 may comprise a computing device, a smart device (e.g., smart glasses, smart watch, smart phone), a mobile device, a tablet, a computing station, a laptop, a digital streaming device, a streaming stick, a television, and/or the like.

The user device 102 may send an association request to the access point 110. The association request may comprise a request to connect to the access point 110 for accessing the first network 116. The association request may comprise one or more management frames 103. The management frame(s) 103 may indicate a rate of change of an SNR (e.g., a variation of energy) associated with the user device 102. The user device 102 may periodically send one of the management frame(s) 103 to the access point 110. For example, the user device 102 may send one of the management frame(s) 103 every 50 milliseconds (ms) to 100 ms.

For example, the management frame(s) 103 may include a first management frame associated with a first time. The first management frame may indicate a first SNR associated with the user device 102 at the first time. The management frame(s) 103 may include a second management frame associated with a second time occurring after the first time. The second management frame may indicate a second SNR associated with the user device 102 at the second time. The management frame(s) 103 may include a third management frame associated with a third time occurring after the second time. The third management frame may indicate a third SNR associated with the user device 102 at the third time. The management frame(s) 103 may include a fourth management frame associated with a fourth time occurring after the third time. The fourth management frame may indicate a fourth SNR associated with the user device 102 at the fourth time. The management frame(s) 103 may include a fifth management frame associated with a fifth time occurring after the fourth time. The fifth management frame may indicate a fifth SNR associated with the user device 102 at the fifth time.

The access point 110 may receive the association request (e.g., the management frame(s) 103). The access point 110 may comprise one or more processors 112. The processor(s) 112 may be configured to determine an SNR associated with each of the management frame(s) 103 as each of the management frame(s) 103 are received (e.g., in real time). To determine the SNR associated with one of the management frame(s) 103, the processor(s) 112 may determine an energy and/or power (e.g., a received signal strength indicator (RSSI)) associated with receipt of the management frame by the access point 110. The processor(s) 112 may determine the energy and/or power associated with receipt of the management frame by the access point 110 based on receiving the management frame in analog form. The processor(s) 112 may determine the SNR associated with the management frame based on the management frame being successfully demodulated, decoded, and determined to be an 802.11 management frame. For example, an amplitude of an analog waveform carrying the management frame may be determined. The amplitude may be compared to a noise amplitude to determine the SNR. The SNR associated with the management frame may be equal to the difference between the RSSI and a noise floor associated with the access point 110. For example, the SNR associated with the management frame may be equal to the noise floor associated with the access point 110 subtracted from the RSSI.

The processor(s) 112 may be configured to determine a rate of change of an SNR (e.g., or other variation of energy) associated with the user device 102 based on the management frames(s) 103. The rate of change of the SNR associated with the user device 102 may indicate the characteristics of the motion of the user device 102 relative to the first network 116. For example, the absolute value of the rate of change of the SNR may indicate how quickly the user device 102 is moving (e.g., the higher the absolute value of the SNR variation, the more quickly the user device 102 may be moving).

As one example, to determine the rate of change of the SNR associated with the user device 102, the processor(s) 112 may determine a difference between the SNR indicated by the fifth management frame (e.g., the management frame that was most recently received at the access point 110) and the SNR indicated by the fourth management frame (e.g., the management frame immediately preceding the management frame that was most recently received at the access point 110). The processor(s) 112 may determine the difference between the fifth time and the fourth time. The rate of change of the SNR associated with the user device 102 may be equal to the difference between the fifth SNR and the fourth SNR divided by the difference between the fifth time and the fourth time.

As another example, to determine the rate of change of the SNR associated with the user device 102, the processor(s) 112 may determine a difference between the SNR indicated by the fifth management frame (e.g., the management frame that was most recently received at the access point 110) and an average (e.g., weighted average) of the SNRs indicated by two or more management frames preceding the management frame that was most recently received at the access point 110. The two or more management frames may comprise, for example, two or more of the fourth management frame, the third management frame, the second management frame, and the first management. The processor(s) 112 may determine, for example, the difference between a difference between the fifth SNR and an average (e.g., weighted average) of the first, second, third, and fourth SNRs. The processor(s) 112 may determine the difference between the fifth time and an average (e.g., weighted average) of the first, second, third, and fourth times. The rate of change of the SNR associated with the user device 102 may be equal to the difference between the fifth SNR and the average (e.g., weighted average) of the first, second, third, and fourth SNRs divided by the difference between the fifth time and the average (e.g., weighted average) of the first, second, third, and fourth times.

The processor(s) 112 may determine if the rate of change of the SNR associated with the user device 102 satisfies an association threshold. The rate of change of the SNR associated with the user device 102 may not satisfy the association threshold if the absolute value of the rate of change of the SNR is above an association threshold. If the rate of change of the SNR associated with the user device 102 does not satisfy the association threshold, this may indicate that the user device 102 is rapidly moving and is therefore likely to disconnect from the first network 116 shortly after being admitted to the first network 116. If the user device 102 is likely to disconnect from the first network 116 shortly after being admitted to the first network 116, the access point 110 may not admit the user device 102 to the first network 116, thereby preventing a transient connection between the user device 102 and the first network 116 from being formed.

Conversely, the rate of change of the SNR associated with the user device 102 may satisfy the association threshold if the absolute value of the rate of change of the SNR is less than or equal to association threshold. If the absolute value of the SNR variation is less than or equal to the association threshold, this may indicate that the user device 102 is not rapidly moving and is therefore not likely to disconnect from the first network 116 shortly after being admitted to the first network 116. If the user device 102 is not likely to disconnect from the first network 116 shortly after being admitted to the first network 116, the access point 110 may admit the user device 102 to the first network 116. If the access point 110 admits the user device to the first network 116, the user device 102 may establish a connection with the access point 110 to access one or more services (e.g., voice communication service, a messaging communication service, and/or a mobile data service) provided by the first network 116.

FIG. 1B is the example system 100 if the access point 110 admits the user device 102 to the first network 116. The user device 102 may be connected to the first network 116 via the access point 110. The user device 102 may send one or more uplink data frames 113 to the access point 110. The data frame(s) 113 may indicate a rate of change of an SNR (e.g., a variation of energy) associated with the user device 102. The user device 102 may periodically send one of the data frame(s) 113 to the access point 110. For example, the user device 102 may send one of the data frame(s) 113 every 5 ms, 10 ms, 15 ms, etc.

For example, the data frame(s) 113 may include a first data frame associated with a first time. The first data frame may indicate a first SNR associated with the user device 102 at the first time. The data frame(s) 113 may include a second data frame associated with a second time occurring after the first time. The second data frame may indicate a second SNR associated with the user device 102 at the second time. The data frame(s) 113 may include a third data frame associated with a third time occurring after the second time. The third data frame may indicate a third SNR associated with the user device 102 at the third time. The data frame(s) 113 may include a fourth data frame associated with a fourth time occurring after the third time. The fourth data frame may indicate a fourth SNR associated with the user device 102 at the fourth time. The data frame(s) 113 may include a fifth data frame associated with a fifth time occurring after the fourth time. The fifth data frame may indicate a fifth SNR associated with the user device 102 at the fifth time.

The access point 110 may receive the data frame(s) 113. The processor(s) 112 may be configured to determine an SNR associated with each of the data frame(s) 113 as the data frame(s) 113 are received. To determine the rate of change of the SNR associated with one of the data frame(s) 113, the processor(s) 112 may determine an energy and/or power (e.g., a received signal strength indicator (RSSI)) associated with receipt of the data frame(s) 113 by the access point 110. The processor(s) 112 may determine the energy and/or power associated with receipt of the data frame(s) 113 by the access point 110 based on receiving the data frame(s) 113 in analog form. The processor(s) 112 may determine an average of the RSSI over N of the data frame(s) 113 based on the N data frames being successfully demodulated, decoded, and determined to be 802.11 data frames. The N data frames may be the N most recently received data frame(s) 113, where N is any positive integer number. The SNR associated with the data frame may be equal to the difference between the RSSI (or the average of the RSSI over the N data frames) and a noise floor associated with the access point 110. For example, the SNR associated with the data frame may be equal to the noise floor associated with the access point 110 subtracted from the RSSI (or the average of the RSSI over the N data frames).

The processor(s) 112 may be configured to determine a rate of change of an SNR (e.g., a variation of energy) associated with the user device 102 based on the data frames(s) 113. The rate of change of the SNR associated with the user device 102 may indicate the characteristics of the motion (if any) of the user device 102 relative to the first network 116. For example, the absolute value of the rate of change of the SNR may indicate how quickly the user device 102 is moving—the higher the absolute value of the SNR variation, the more quickly the user device 102 may be moving.

As one example, to determine the rate of change of the SNR associated with the user device 102, the processor(s) 112 may determine a difference between the SNR indicated by the fifth data frame (e.g., the data frame that was most recently received at the access point 110) and the SNR indicated by the fourth data frame (e.g., the data frame immediately preceding the data frame that was most recently received at the access point 110). The processor(s) 112 may determine the difference between the fifth time and the fourth time. The rate of change of the SNR associated with the user device 102 may be equal to the difference between the fifth SNR and the fourth SNR divided by the difference between the fifth time and the fourth time.

As another example, to determine the rate of change of the SNR associated with the user device 102, the processor(s) 112 may determine a difference between the SNR indicated by the fifth data frame (e.g., the data frame that was most recently received at the access point 110) and an average (e.g., weighted average) of the SNRs indicated by two or more data frames preceding the data frame that was most recently received at the access point 110. The two or more data frames may comprise, for example, two or more of the fourth data frame, the third data frame, the second data frame, and the first data. The processor(s) 112 may determine, for example, the difference between a difference between the fifth SNR and an average (e.g., weighted average) of the first, second, third, and fourth SNRs. The processor(s) 112 may determine the difference between the fifth time and an average (e.g., weighted average) of the first, second, third, and fourth times. The rate of change of the SNR associated with the user device 102 may be equal to the difference between the fifth SNR and the average (e.g., weighted average) of the first, second, third, and fourth SNRs divided by the difference between the fifth time and the average (e.g., weighted average) of the first, second, third, and fourth times.

The processor(s) 112 may determine if the rate of change of the SNR associated with the user device 102 satisfies a disassociation threshold. The rate of change of the SNR associated with the user device 102 may not satisfy the disassociation threshold if the absolute value of the rate of change of the SNR is less than or equal to disassociation threshold. If the absolute value of the SNR variation is less than or equal to the disassociation threshold, this may indicate that the user device 102 is not rapidly moving away from the access point 110 (and is therefore unlikely to move out of range of the access point 110). If the user device 102 is unlikely to move out of range of the access point 110, the access point 110 not force the user device 102 to disconnect from the first network 116. The user device 102 may remain connected to the first network 116 via the access point 110.

Conversely, the rate of change of the SNR associated with the user device 102 may satisfy the disassociation threshold if the absolute value of the rate of change of the SNR is above the disassociation threshold. If the rate of change of the SNR associated with the user device 102 satisfies the disassociation threshold, this may indicate that the user device 102 is rapidly moving away from the access point 110 (and is therefore likely to move out of range of the access point 110). If the user device 102 is likely to move out of range of the access point 110, the access point 110 may force the user device 102 to disconnect from the first network 116 (e.g., while the user device 102 is still located within a coverage area of the access point 110), thereby minimizing the number of transient connections that exist within the network and minimizing network resource consumption by the user device 102.

To force the user device 102 to disconnect from the first network 116, the access point 110 may send one or more de-authentication frames to the user device 102. The user device 102 may disconnect from the access point 110 based on (e.g., in response to) receiving the de-authentication frames. If the user device 102 disconnects from the access point 110, the access point 110 may ignore requests from the user device 102 to re-connect to the access point 110, thereby preventing the user device 102 from establishing another transient connection with the access point 110. For example, the access point 110 may ignore requests from the user device 102 to re-connect to the access point 110 for a pre-determined duration (e.g., five minutes, ten minutes, one hour, etc.)

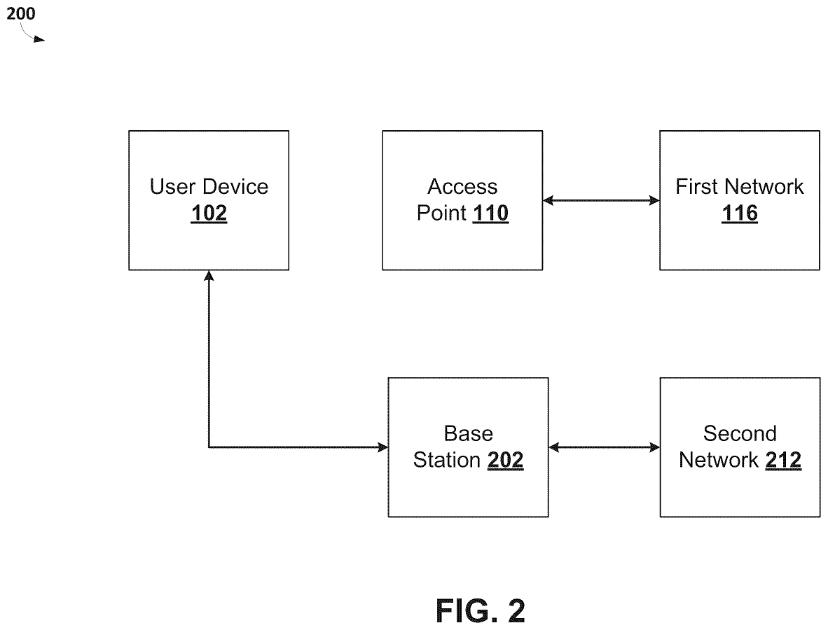

FIG. 2 is an example system 200 if the access point 110 forces the user device 102 to disconnect from the first network 116. If the access point 110 forces the user device 102 to disconnect from the first network 116, the user device 102 may establish a connection with a second network 212 to maintain continuity of service to the user device 102. The user device 102 may establish a connection with the second network 212 via a base station 202 of the second network 212. The second network 212 may comprise a different type of network than the first network 116. For example, the first network 116 may comprise a Wi-Fi network and the second network 212 may comprise a cellular network.

The second network 212 may comprise a service entity, content provider (e.g., distributor) and/or access network. The second network 212 may facilitate communication via one or more communication protocols. The second network 212 may comprise any of a variety of types of networks, such as, for example, a coaxial cable network, a fiber-optic cable network, a hybrid fiber-coaxial (HFC) network, a satellite transmission channel, a DSL connection, or the like. The second network 212 may comprise fiber, cable, a combination thereof. The second network 212 may comprise wired links, wireless links, a combination thereof, and/or the like. The second network 212 may comprise routers, switches, nodes, gateways, servers, modems, and/or the like. The second network 212 may comprise one or more networks, such as a wide area network (e.g., the Internet), a cellular network, a Wi-Fi network, a Long Term Evolution (LTE) network, one or more service entity networks, and/or the like. The second network 212 may be a converged network, having capabilities to route traffic over various communication networks, such as a cellular network, a Wi-Fi network, etc.

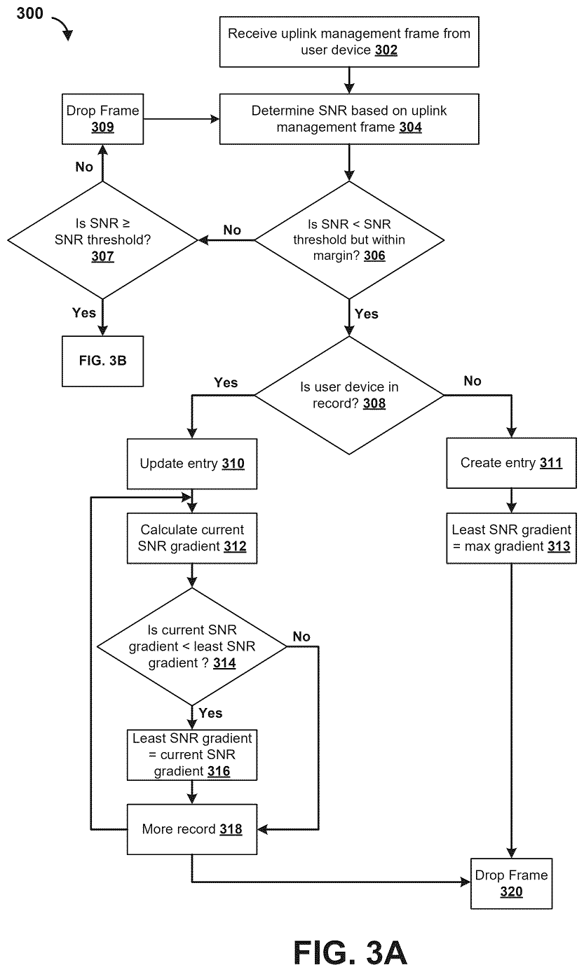

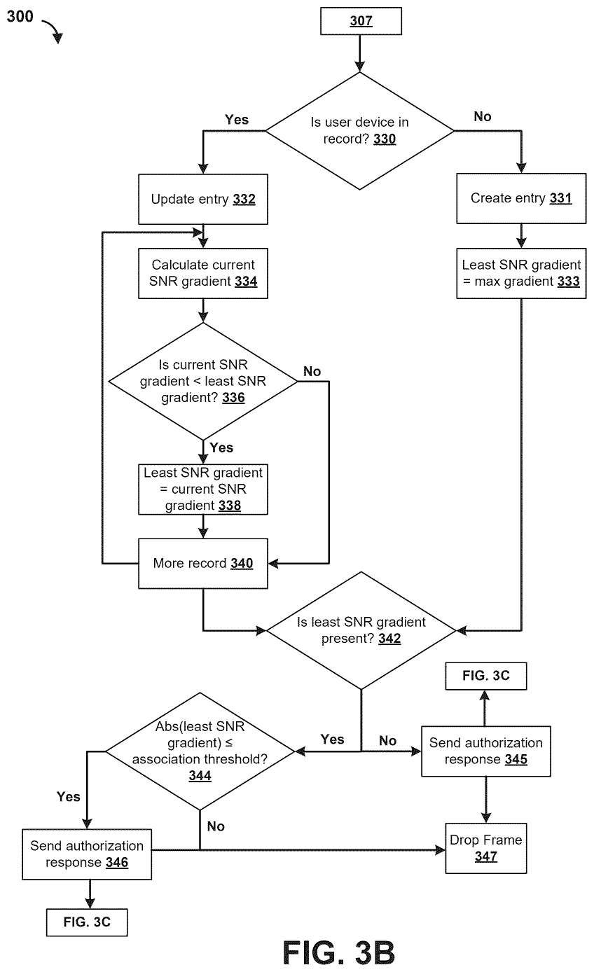

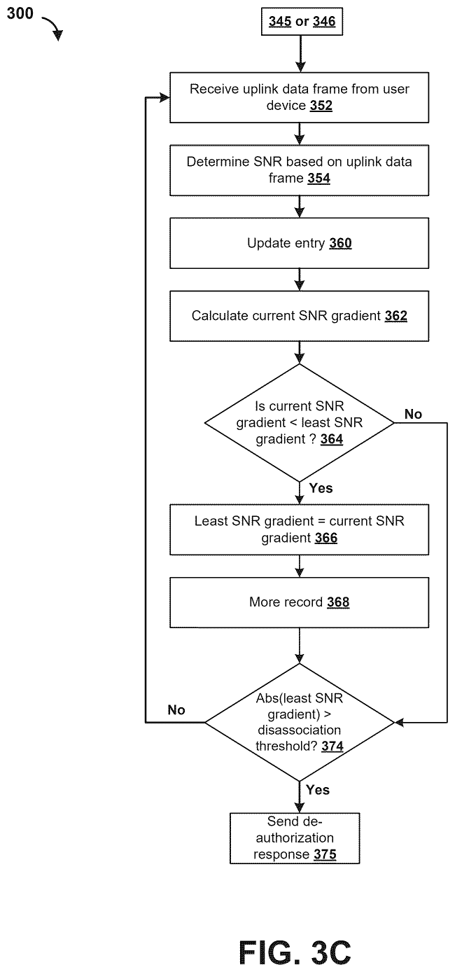

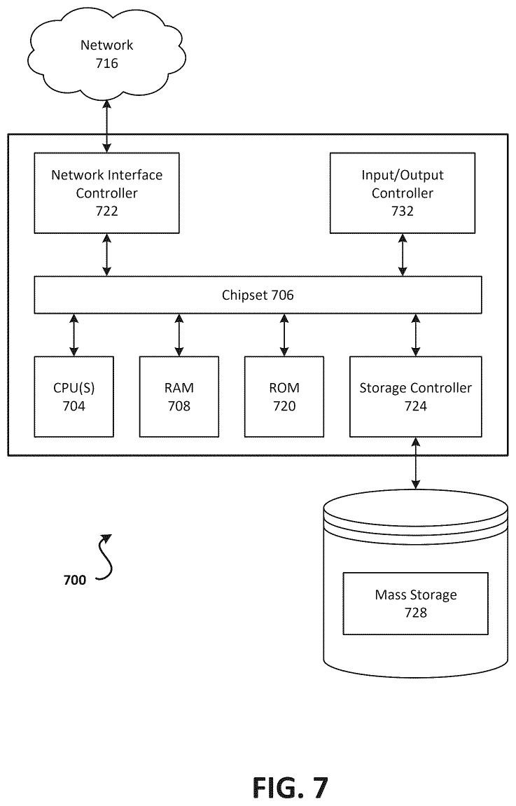

FIGS. 3A-C are an example method 300. The method 300 may comprise a computer implemented method for connection management. A computing device, a system and/or computing environment, such as the system 100 of FIG. 1 and/or the computing environment of FIG. 7, may be configured to perform the method 300. For example, the access point 110 of FIG. 1 may be configured to perform the method 300.

A user device (e.g., user device 102) may send one or more uplink management frames (e.g., management frame(s) 103) to an access point (e.g., access point 110) of a network (e.g., first network 116). The user device may periodically send a management frame to the access point. For example, the user device may send a management frame to the access point every 50 milliseconds (ms) to 100 ms. At 302, the uplink management frame(s) may be received. The management frame(s) may indicate a rate of change of an SNR (e.g., a variation of energy) associated with the user device. At 304, an SNR (e.g., a current SNR) associated with the user device may be determined. The SNR associated with the user device may be determined based on (e.g., using) the management frame(s). At 306, it may be determined if the SNR associated with the user device fails to satisfy a SNR threshold associated with the network but is within an acceptable margin of the SNR threshold. The SNR associated with the user device may fail to satisfy the SNR threshold if the SNR associated with the user device is less than the SNR threshold. The SNR associated with the user device may be within an acceptable margin of the SNR threshold if the SNR associated with the user device is greater than or equal to the difference between the SNR threshold and a predefined margin.

If either of the two conditions at 306 are not satisfied, the method 300 may proceed to 307. At 307, it may be determined if the SNR associated with the user device satisfies the SNR threshold associated with the network. The SNR associated with the user device may satisfy the SNR threshold if the SNR associated with the user device is greater than or equal to the SNR threshold. If the SNR associated with the user device does not satisfy the SNR threshold, this may indicate that the user device is not close enough to the access point to be permitted to associate with the access point. If the user device is not close enough to the access point to be permitted to associate with the access point, the method 300 may proceed to 309. At 309, the management frame may be dropped (e.g., ignored). If the management frame is dropped, the user device may not admit the user device to the network. The method 300 may return to 304. The SNR of the user device may continue to be monitored. Conversely, if the SNR associated with the user device satisfies the SNR threshold, this may indicate that the user device is close enough to the access point to be permitted to associate with the access point. If the user device is close enough to the access point to be permitted to associate with the access point, the method 300 may proceed to 330 shown in FIG. 3B.

If both of the two conditions at 306 are satisfied, this may indicate that, although the SNR associated with the user device does not yet satisfy the SNR threshold, the SNR associated with the user device is close to satisfying the SNR threshold. The method 300 may proceed to 308. At 308, it may be determined if an entry including a user identification (ID) of the user device is stored (e.g., on a storage local to or accessible by the access point). The user ID may comprise, for example, a Media Access Control (MAC) address associated with the user device. If an entry comprising the user ID is not identified, the method 300 may proceed to 311. At 311, a new entry associated with the user ID may be created. At 313, the new entry may be updated to indicate the current SNR determined at 304. For example, the new entry may be updated to indicate that the current SNR is the lowest recorded SNR associated with the user device. The method 300 may proceed to 320. At 320, the management frame may be dropped (e.g., ignored). If the management frame is dropped, the user device may not admit the user device to the network.

Conversely, if an entry comprising the user ID is identified at 308, the method 300 may proceed to 310. At 310, the entry may be updated based on the current SNR determined at 304. At 312, the current rate of change of the SNR (e.g., the SNR gradient) associated with the user device may be determined. The rate of change of the SNR associated with the user device may indicate the characteristics of the motion (if any) of the user device relative to the network. For example, the absolute value of the rate of change of the SNR may indicate how quickly the user device is moving—the higher the absolute value of the SNR variation, the more quickly the user device may be moving. The rate of change of the SNR associated with the user device may be determined based on the current SNR determined at 304 and one or more previous SNRs associated with the user device, as indicated in the entry.

At 314, it may be determined if the current rate of change of the SNR associated with the user device is less than the lowest previously calculated rate of change of SNR associated with the user device. If the current rate of change of the SNR associated with the user device is less than the lowest previously calculated rate of change of SNR associated with the user device, the method 300 may proceed to 316. At 316, the current rate of change of the SNR may be set as the new lowest rate of change of SNR associated with the user device. At 318, the entry may be updated based on the new lowest rate of change of SNR associated with the user device. If the entry is updated based on the new lowest rate of change of SNR associated with the user device, the method 300 may return to 312, and the rate of change of the SNR associated with the user device may continue to be calculated as new management frames are received. If the entry is updated based on the new lowest rate of change of SNR associated with the user device, the method 300 may proceed to 320. At 320, the management frame may be dropped (e.g., ignored). If the management frame is dropped, the user device may not admit the user device to the network.

As described above, if it is determined at 307 that the SNR associated with the user device satisfies the SNR threshold, this may indicate that the user device is close enough to the access point to be permitted to associate with the access point. If the user device is close enough to the access point to be permitted to associate with the access point, the method 300 may proceed to 330 shown in FIG. 3B.

At 330, it may be determined if an entry including a user ID of the user device is stored (e.g., on a storage local to or accessible by the access point). The user ID may comprise, for example, a Media Access Control (MAC) address associated with the user device. If an entry comprising the user ID is not identified, the method 300 may proceed to 331. At 331, a new entry associated with the user ID may be created. At 333, the new entry may be updated to indicate the current SNR determined at 304. For example, the new entry may indicate that the current SNR is the lowest recorded SNR associated with the user device. The method 300 may proceed to 342.

Conversely, if an entry comprising the user ID is identified at 330, the method 300 may proceed to 332. At 332, the entry may be updated based on the current SNR determined at 304. At 334, the current rate of change of the SNR (e.g., the SNR gradient) associated with the user device may be determined. The rate of change of the SNR associated with the user device may indicate the characteristics of the motion (if any) of the user device relative to the network. For example, the absolute value of the rate of change of the SNR may indicate how quickly the user device is moving—the higher the absolute value of the SNR variation, the more quickly the user device may be moving. The rate of change of the SNR associated with the user device may be determined based on the current SNR determined at 304 and one or more previous SNRs associated with the user device, as indicated in the entry.

At 336, it may be determined if the current rate of change of the SNR associated with the user device is less than the lowest previously calculated rate of change of SNR associated with the user device. If the current rate of change of the SNR associated with the user device is less than the lowest previously calculated rate of change of SNR associated with the user device, the method 300 may proceed to 338. At 338, the current rate of change of the SNR may be set as the new lowest rate of change of SNR associated with the user device. At 340, the entry may be updated based on the new lowest rate of change of SNR associated with the user device. If the entry is updated based on the new lowest rate of change of SNR associated with the user device, the method 300 may return to 334, and the rate of change of the SNR associated with the user device may continue to be calculated as new management frames are received. If the entry is updated based on the new lowest rate of change of SNR associated with the user device, the method 300 may also proceed to 342.

At 342, it may be determined if the lowest recorded rate of change of SNR associated with the user device is present. For example, it may be determined if the current rate of change of SNR is equal to the lowest recorded rate of change of SNR associated with the user device. If the lowest recorded rate of change of SNR associated with the user device is not present, the method 300 may proceed to 345. At 345, an authorization response may be sent to the user device. The user device may receive the authorization response. Based on receiving the authorization response, the user device may establish a connection with the network via the access point. If the user device establishes a connection with the network via the access point, the method may proceed to 352 shown in FIG. 3C. If the user device establishes a connection with the network via the access point, the method 300 may proceed to 347. At 347, the management frame may be dropped (e.g., ignored). If the management frame is dropped, the user device may not admit the user device to the network.

If the lowest recorded rate of change of SNR associated with the user device is present, the method 300 may proceed to 344. At 344, it may be determined if the absolute value of the lowest current rate of change of SNR satisfies an association threshold. The absolute value of the lowest rate of change of SNR may satisfy the association threshold if the absolute value of the current rate of change of SNR is less than or equal to the association threshold.

If the absolute value of the current rate of change of SNR does not satisfy the association threshold (e.g., the absolute value of the current rate of change of SNR is greater than the association threshold), this may indicate that the user device is rapidly moving and is therefore likely to disconnect from the network shortly after being admitted to the network. If the absolute value of the current rate of change of SNR does not satisfy the association threshold, the method 300 may proceed to 347. At 347, the management frame may be dropped (e.g., ignored). If the management frame is dropped, the user device may not admit the user device to the network.

Conversely, if the absolute value of the current rate of change of SNR satisfies the association threshold, this may indicate that the user device is not rapidly moving and is therefore not likely to disconnect from the network shortly after being admitted to the network. If the absolute value of the current rate of change of SNR satisfies the association threshold, the method 300 may proceed to 346. At 346, an authorization response may be sent to the user device. The user device may receive the authorization response. Based on receiving the authorization response, the user device may establish a connection with the network via the access point. If the user device establishes a connection with the network via the access point, the method may proceed to 352 shown in FIG. 3C. If the user device establishes a connection with the network via the access point, the method 300 may proceed to 347. At 347, the management frame may be dropped (e.g., ignored). If the management frame is dropped, the user device may not admit the user device to the network.

As described above, if the user device establishes a connection with the network via the access point (e.g., at 345 or 346), the method 300 may proceed to 352 shown in FIG. 3C. If the user device establishes a connection with the network via the access point, the user device may periodically send an uplink data frame to the access point. At 352, an uplink data frame may be received from the user device. The management frame(s) may indicate a rate of change of an SNR (e.g., a variation of energy) associated with the user device. At 354, an SNR (e.g., a current SNR) associated with the user device may be determined. The SNR associated with the user device may be determined based on (e.g., using) the uplink data frame. At 360, the entry associated with the user ID of the user device may be updated to indicate the current SNR determined at 354.

At 362, the current rate of change of the SNR (e.g., the SNR gradient) associated with the user device may be determined. The rate of change of the SNR associated with the user device may indicate the characteristics of the motion (if any) of the user device relative to the network. For example, the absolute value of the rate of change of the SNR may indicate how quickly the user device is moving—the higher the absolute value of the SNR variation, the more quickly the user device may be moving. The rate of change of the SNR associated with the user device may be determined based on the current SNR determined at 354 and one or more previous SNRs associated with the user device, as indicated in the entry.

At 364, it may be determined if the current rate of change of the SNR associated with the user device is less than the lowest previously calculated rate of change of SNR associated with the user device. If the current rate of change of the SNR associated with the user device is greater than or equal to the lowest previously calculated rate of change of SNR associated with the user device, the method 300 may proceed to 374. If the current rate of change of the SNR associated with the user device is less than the lowest previously calculated rate of change of SNR associated with the user device, the method 300 may proceed to 366. At 366, the current rate of change of the SNR may be set as the new lowest rate of change of SNR associated with the user device. At 368, the entry may be updated based on the new lowest rate of change of SNR associated with the user device.

At 374, it may be determined if the absolute value of the lowest rate of change of SNR satisfies a disassociation threshold. The absolute value of the lowest rate of change of SNR may satisfy the disassociation threshold if the absolute value of the lowest rate of change of SNR is greater than the disassociation threshold. If the absolute value of the lowest rate of change of SNR is greater than the disassociation threshold, this may indicate that the user device is rapidly moving away from the access point.

If the absolute value of the lowest rate of change of SNR does not satisfy the disassociation threshold (e.g., is less than or equal to the disassociation threshold), this may indicate that the connected user device is not rapidly moving away from the access point. If the user device is not rapidly moving away from the access point, the access point may not force the user device to disconnect from the network. The user device may remain connected to the network via the access point. The method 300 may return to 352. The access point may continue to monitor the absolute value of the rate of change of SNR. If the user device later begins to rapidly move away from the access point, the access point may force the user device to disconnect from the network.

Conversely, if the absolute value of the lowest rate of change of SNR satisfies the disassociation threshold, the method 300 may proceed to 375. At 375, a de-authorization response (e.g., a de-authentication frame) may be sent to the user device. Sending the de-authorization response to the user device may force the user device to disconnect from the network (e.g., while the user device is still located within a coverage area of the access point), thereby minimizing the number of transient connections that exist within the network.

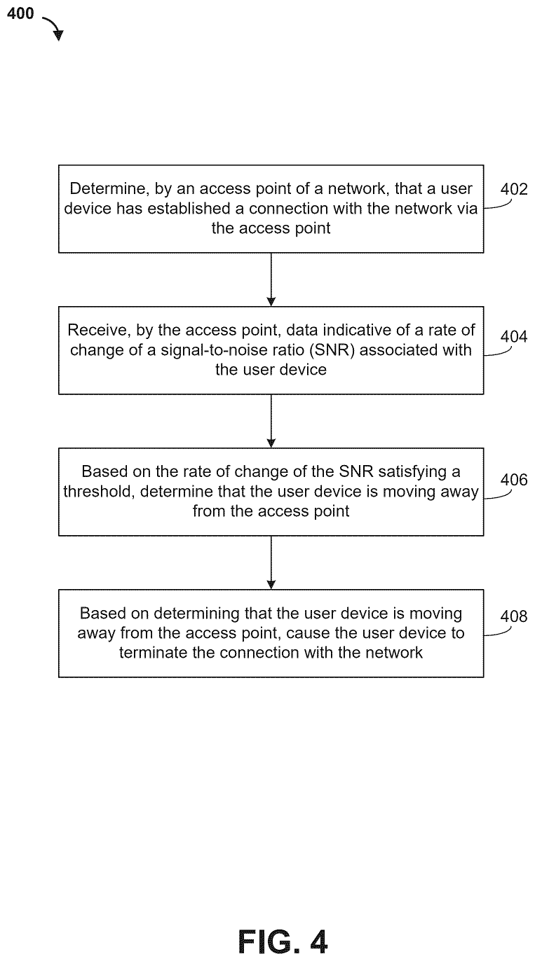

FIG. 4 is an example method 400. The method 400 may comprise a computer implemented method for connection management. A computing device, a system and/or computing environment, such as the system 100 of FIG. 1 and/or the computing environment of FIG. 7, may be configured to perform the method 400. For example, the access point 110 of FIG. 1 may be configured to perform the method 400.

At 402, it may be determined that a user device has established a network connection via an access point. The access point may determine that the user device has established the connection with the network. The user device may establish the connection with the network based on a rate of change of an SNR (e.g., a variation of energy) associated with the user device satisfying an association threshold.

At 404, data indicative of the rate of change of the SNR associated with the user device may be received. The data indicative of the rate of change of the SNR associated with the user device may be received by the access point. Receiving the data indicative of the rate of change of the SNR associated with the user device may comprise receiving a plurality of uplink data frames from the user device. The uplink data frames may indicate the rate of change of the SNR associated with the user device. The rate of change of the SNR associated with the user device may indicate the characteristics of the motion (if any) of the user device relative to the network. For example, the rate of change of the SNR (e.g., the absolute value of the rate of change of the SNR) may indicate how quickly the user device is moving—the higher the rate of change of the SNR (e.g., the higher the absolute value of the SNR variation), the more quickly the user device may be moving.

At 406, it may be determined that the user device is moving away from the access point. Determining that the user device is moving away from the access point may comprise determining that the rate of change of the SNR (e.g., an absolute value of the rate of change of the SNR) associated with the user device satisfies a disassociation threshold. If the rate of change of the SNR associated with the user device satisfies the disassociation threshold, this may indicate that the user device is rapidly moving away from the access point (and is therefore likely to move out of range of the access point).

At 408, the user device may be caused to terminate the connection with the network. The user device may be caused to terminate the connection with the network based on determining that the user device is rapidly moving away from the access point (e.g., and is therefore likely to move out of range of the access point). The user device may be caused to terminate the connection with the network while the user device is still located within a coverage area of the access point, thereby minimizing the number of transient connections that exist within the network and minimizing network resource consumption by the user device. Causing the user device to terminate the connection with the network may comprise sending a de-authentication frame to the user device. The user device may terminate the connection with the network based on (e.g., in response to) receiving the de-authentication frame. Causing the user device to terminate the connection with the network may comprise causing the user device to establish a connection with a different type of network (e.g., a cellular network), thereby maintaining continuity of service to the user device.

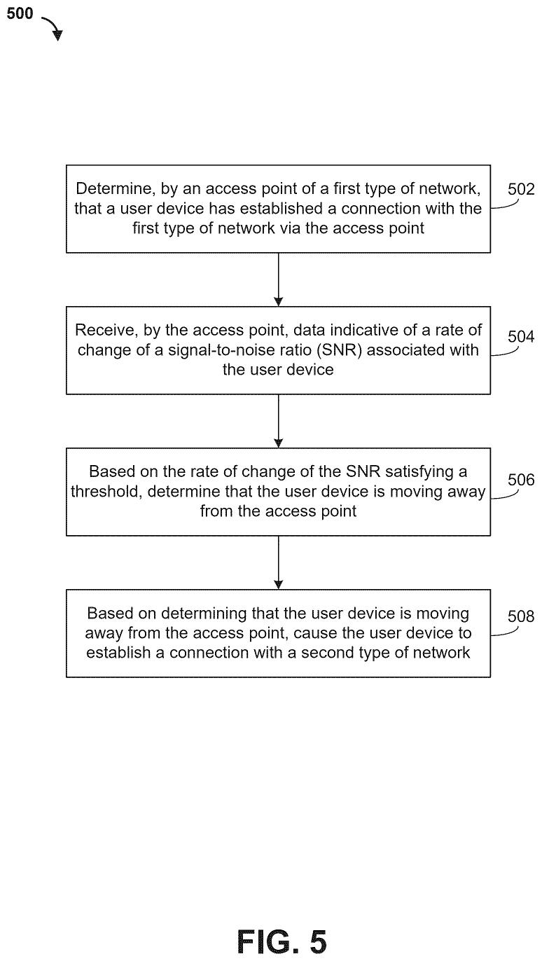

FIG. 5 is an example method 500. The method 500 may comprise a computer implemented method for connection management. A system and/or computing environment, such as the system 100 of FIG. 1 and/or the computing environment of FIG. 7, may be configured to perform the method 500. For example, the access point 110 of FIG. 1 may be configured to perform the method 500.

At 502, it may be determined that a user device has established a connection with a first type of network (e.g., a Wi-Fi network) via an access point of the first type of network. The access point of the first type of network may determine that the user device has established the connection with the first type of network. The user device may establish the connection with the first type of network based on a rate of change of an SNR (e.g., a variation of energy) associated with the user device satisfying an association threshold.

At 504, data indicative of the rate of change of the SNR associated with the user device may be received. The data indicative of the rate of change of the SNR associated with the user device may be received by the access point. Receiving the data indicative of the rate of change of the SNR associated with the user device may comprise receiving a plurality of uplink data frames from the user device. The uplink data frames may indicate the rate of change of the SNR associated with the user device. The rate of change of the SNR associated with the user device may indicate the characteristics of the motion (if any) of the user device relative to the first type of network. For example, the rate of change of the SNR (e.g., the absolute value of the rate of change of the SNR) may indicate how quickly the user device is moving—the higher the rate of change of the SNR (e.g., the absolute value of the rate of change of the SNR), the more quickly the user device may be moving.

At 506, it may be determined that the user device is moving away from the access point. Determining that the user device is moving away from the access point may comprise determining that the rate of change of the SNR (e.g., an absolute value of the rate of change of the SNR) associated with the user device satisfies a disassociation threshold. If the rate of change of the SNR associated with the user device satisfies the disassociation threshold, this may indicate that the user device is rapidly moving away from the access point (and is therefore likely to move out of range of the access point).

At 508, the user device may be caused to establish a connection with a second type of network (e.g., a cellular network). The user device may be caused to establish the connection with the second type of network based on determining that the user device is rapidly moving away from the access point (and is therefore likely to move out of range of the access point). Causing the user device to establish a connection with the second type of network may comprise causing the user device to terminate the connection with the first type of network. The user device may be caused to terminate the connection with the first type of network while the user device is still located within a coverage area of the access point. Causing the user device to terminate the connection with the first type of network may comprise sending a de-authentication frame to the user device. The user device may terminate the connection with the first type of network based on (e.g., in response to) receiving the de-authentication frame.

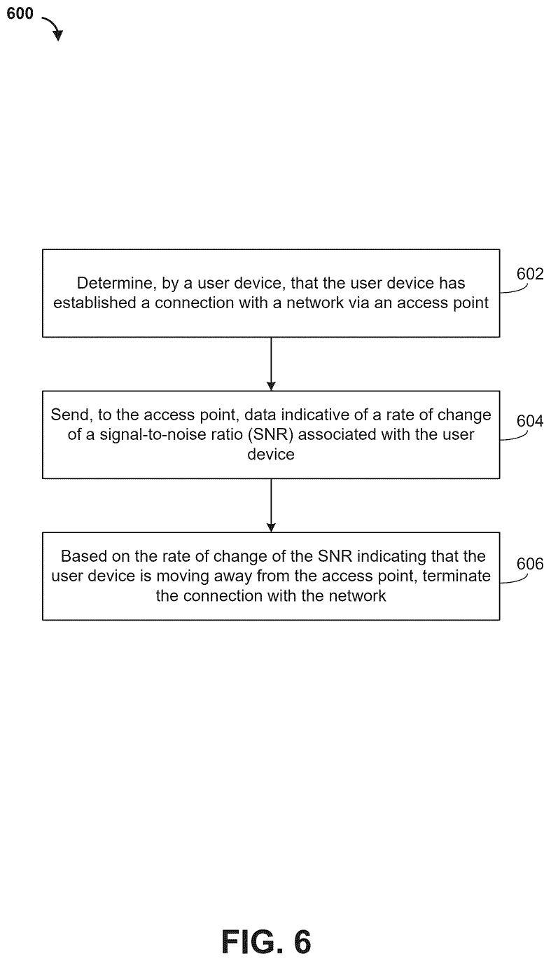

FIG. 6 is an example method 600. The method 600 may comprise a computer implemented method for connection management. A system and/or computing environment, such as the system 100 of FIG. 1 and/or the computing environment of FIG. 7, may be configured to perform the method 600. For example, the access point 110 of FIG. 1 may be configured to perform the method 600.

At 602, it may be determined that a user device has established a network connection via an access point. The user device may determine that the user device has established the connection with the network. The user device may establish the connection with the network based on the access point determining that a rate of change of an SNR (e.g., a variation of energy) associated with the user device satisfied an association threshold.

At 604, data indicative of the rate of change of the SNR associated with the user device may be sent. The data indicative of the rate of change of the SNR associated with the user device may be sent by the user device and to the access point. Sending the data indicative of the rate of change of the SNR associated with the user device may comprise sending a plurality of uplink data frames from the user device. The uplink data frames may indicate the rate of change of the SNR associated with the user device. The rate of change of the SNR associated with the user device may indicate the characteristics of the motion (if any) of the user device relative to the first type of network. For example, the rate of change of the SNR (e.g., the absolute value of the rate of change of the SNR) may indicate how quickly the user device is moving—the higher the rate of change of the SNR (e.g., the absolute value of the rate of change of the SNR), the more quickly the user device may be moving.

At 606, the connection between the user device and the network may be terminated. The connection between the user device and the network may be terminated based on receiving a de-authentication frame from the access point. The access point may send the de-authentication frame to the user device based on determining that the user device is moving away from the access point. it may be determined that the user device is moving away from the access point. The access point may determine that the user device is moving away from the access point based on determining that the rate of change of the SNR (e.g., an absolute value of the rate of change of the SNR) associated with the user device satisfies a disassociation threshold. If the rate of change of the SNR associated with the user device satisfies the disassociation threshold, this may indicate that the user device is rapidly moving away from the access point (and is therefore likely to move out of range of the access point).

FIG. 7 depicts a computing device that may be used in various aspects, such as the servers and/or devices depicted in FIG. 1. With regard to the example architecture of FIG. 1, any of the components or devices may each be implemented in an instance of a computing device 700 of FIG. 7.

The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3A-6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s). The GPU(s) may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to FIGS. 6-11.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining, by an access point, that a user device has established a connection with a network via the access point;
receiving, by the access point and from the user device, data indicative of a rate of change of a signal-to-noise ratio (SNR) associated with the user device;
based on the rate of change of the SNR satisfying a threshold, determining that the user device is moving away from the access point; and
based on determining that the user device is moving away from the access point, causing the user device to terminate the connection with the network.

2. The method of claim 1, wherein the network comprises a first type of network, and wherein causing the user device to terminate the connection with the network comprises causing the user device to establish a connection with a second type of network, the second type of network being different from the first type of network.

3. The method of claim 1, wherein receiving, by the access point and from the user device, the data indicative of the rate of change of the SNR associated with the user device comprises receiving a plurality of uplink data frames indicative of the SNR associated with the user device.

4. The method of claim 1, wherein causing the user device to terminate the connection with the network comprises causing the user device to disassociate with the access point while the user device is located within a coverage area of the access point.

5. The method of claim 1, wherein causing the user device to terminate the connection with the network comprises sending a de-authentication frame to the user device.

6. The method of claim 1, further comprising:
based on causing the user device to terminate the connection with the network, ignoring a request from the user device to reestablish the connection with the network.

7. The method of claim 1, wherein the rate of change of the SNR satisfies the threshold if an absolute value of the rate of change of the SNR is greater than or equal to the threshold.

8. The method of claim 1, wherein the network comprises a Wi-Fi network.

9. The method of claim 1, wherein the access point comprises one or more of a gateway device, a router, a modem, or a device controller.

10. The method of claim 1, wherein the user device comprises one or more of a smart device, a mobile device, or a streaming device.

11. A method comprising:
determining, by an access point of a first type of network, that a user device has established a connection with the first type of network via the access point;
receiving, by the access point and from the user device, data indicative of a rate of change of a signal-to-noise ratio (SNR) associated with the user device; and
based on the rate of change of the SNR satisfying a threshold, determining that the user device is moving away from the access point; and
based on determining that the user device is moving away from the access point, causing the user device to establish a connection with a second type of network.

12. The method of claim 11, wherein causing the user device to establish the connection with the second type of network comprises causing the user device to terminate the connection with the first type of network.

13. The method of claim 11, wherein receiving, by the access point and from the user device, the data indicative of the rate of change of the SNR associated with the user device comprises receiving a plurality of uplink data frames indicative of the SNR associated with the user device.

14. The method of claim 11, wherein causing the user device to establish a connection with the second type of network comprises sending, by the access point, a de-authentication frame to the user device.

15. The method of claim 11, wherein the rate of change of the SNR satisfies the threshold if an absolute value of the rate of change of the SNR is greater than or equal to the threshold.

16. A method comprising:
determining, by a user device, that the user device has established a connection with a network via an access point;
sending, to the access point, data indicative of a rate of change of a signal-to-noise ratio (SNR) associated with the user device; and
based on the rate of change of the SNR indicating that the user device is moving away from the access point, terminating the connection with the network.

17. The method of claim 16, wherein sending, to the access point, the data indicative of the rate of change of the SNR associated with the user device comprises sending a plurality of uplink data frames indicative of the SNR associated with the user device.

18. The method of claim 16, wherein terminating the connection with the network comprises disassociating from the access point while the user device is located within a coverage area of the access point.

19. The method of claim 16, further comprising receiving, based on the rate of change of the SNR indicating that the user device is moving away from the access point, a de-authentication frame from the access point, wherein terminating the connection with the network is based on receiving the de-authentication frame.

20. The method of claim 16, wherein the network comprises a first type of network, the method further comprising establishing a connection with a second type of network based on terminating the connection with the network, the second type of network being different from the first type of network.
